(19) United States
(12) Patent Application Publication
(10) Pub. No.: US 2024/0116100 A1
(43) Pub. Date: Apr. 11, 2024

(54) METHOD FOR PRODUCING AN END WALL OF A MOTOR VEHICLE BODY, AND METHOD FOR PRODUCING END WALLS OF MOTOR VEHICLE BODIES OF DIFFERENT MOTOR VEHICLE TYPES

(71) Applicant: Volkswagen Aktiengesellschaft, Wolfsburg (DE)

(72) Inventors: Christian SCHWERING, Gross Hesepe (DE); Thomas PAULSEN, Wolfsburg (DE); Werner KRAUTH, Wolfsburg (DE)

(73) Assignee: Volkswagen Aktiengesellschaft, Wolfsburg (DE)

(21) Appl. No.: 18/542,732

(22) Filed: Dec. 17, 2023

Related U.S. Application Data
(63) Continuation of application No. PCT/EP2022/061678, filed on May 2, 2022.

(30) Foreign Application Priority Data
Jun. 22, 2021 (DE) 10 2021 206 368.3

(51) Int. Cl. B21D 47/04; B21D 53/88; B23K 26/24

(52) U.S. Cl. CPC B21D 47/04; B21D 53/88; B23K 26/24

(57) ABSTRACT

A method for the manufacture of a bulkhead of a motor vehicle body and method for the manufacture of bulkheads of motor vehicle bodies of different types of motor vehicles. The front wheel arches of the motor vehicle body are at least partly formed by the bulkhead of the motor vehicle. A component with a spatial structure is manufactured from a two-dimensional metallic semi-finished product by forming, wherein the component forms at least part of the bulkhead. The component manufactured by the forming forms at least a large part of the bulkhead in relation to the area of the projection of the bulkhead in the longitudinal direction of the motor vehicle and extends at least over sections of both front wheel arches of the motor vehicle body.

This nonprovisional application is a continuation of International Application No. PCT/EP2022/061678, which was filed on May 2, 2022, and which claims priority to German Patent Application No. 10 2021 206 368.3, which was filed in Germany on Jun. 22, 2021, and which are both herein incorporated by reference.

### BACKGROUND OF THE INVENTION

### Field of the Invention

The invention relates to a method for the manufacture of a bulkhead of a motor vehicle body and a method for the manufacture of bulkheads for motor vehicle bodies of a number of different types of motor vehicles.

### Description of the Background Art

Bulkheads of the type at issue are two-dimensional structures which form a separation between the passenger compartment and the front end of a motor vehicle. Historically, such bulkheads have also been referred to as “firewalls” because they were used in early motor vehicles to protect passengers from a fire in the engine compartment.

In modern vehicle bodies, however, such fire walls are composed of a large number of comparatively small-scale sheet metal parts, especially due to their complicated three-dimensional design, which thus form the desired separating layer between the passenger cell and the front end. In this case, parts of the fire wall regularly form sections of both front wheel arches. Also, modern bulkheads no longer form a closed barrier, but rather also have openings through which other elements of the motor vehicle are passed. The spatial requirements of modern motor vehicle bodies also require complex shapes in the area of the bulkhead, which require high degrees of deformation in the parts of the fire wall that are mainly made of sheet metal. In addition, different areas of the bulkhead are subjected to different levels of mechanical stress and, especially in the event of a crash, must absorb different forces or exhibit a certain desired deformation behavior. This may require the metal sheets to have mechanical reinforcements in certain areas.

From the state of the art, e.g., DE 10 2011 086 813 A1, which corresponds to US 2014/0193659) or DE 101 35 647 C1, components are therefore known in which the forming of previously reinforced sheets can also be used to manufacture complexly shaped, locally reinforced components. Forming enables the use of high-strength materials, especially high-strength steels. According to the state of the art, parts of the bulkhead can thus be manufactured in an advantageous manner.

However, this does not change the fact that the manufacturing of the bulkheads of modern motor vehicles is still comparatively complex, as a large number of individual parts with complex geometry have to be assembled and connected to form a bulkhead. This leads to a large number of weld seams that have to be subsequently treated at great expense for the purpose of corrosion protection, for example by having to be provided with PVC sealing seams.

### SUMMARY OF THE INVENTION

It is therefore an object of the invention to provide a method for the manufacturing of a bulkhead of a motor vehicle body as well as a method for the manufacturing of bulkheads for motor vehicle bodies of a number of different types of motor vehicles, which enable a more cost-effective manufacturing of the bulkhead.

The purpose of the method is to manufacture a bulkhead of a motor vehicle body in which the front wheel arches of the motor vehicle body are formed, at least in part, by the bulkhead of the motor vehicle. In the manufacturing of the bulkhead, a component with a spatial structure is manufactured from a two-dimensional metallic semi-finished product by means of forming. This component forms at least part of the bulkhead.

The method for the manufacturing of a bulkhead of a motor vehicle body provides that the component manufactured by the forming forms at least one part of the bulkhead extending at least over sections of both front wheel arches of the motor vehicle body.

It has been shown that by means of the forming of two-dimensional metallic semi-finished products, such large areas of the bulkhead can be made of a semi-finished product, so that the number of individual parts to be assembled into the bulkhead during the construction of the motor vehicle body is considerably reduced. In particular, the use of such large two-dimensional semi-finished products, that the component manufactured by the forming process can extend over sections of both front wheel arches, leads to a significant reduction in the effort required to install the bulkhead.

The bulkhead can be completely formed by the component manufactured by the forming process. Such a one-piece bulkhead of a motor vehicle represents the maximum possible simplification with regard to the manufacture of the bulkhead. In addition, such a one-piece bulkhead has good mechanical properties, especially with regard to the protection of the persons in the passenger compartment. As a one-piece, large-area component, such a bulkhead acts in the form of a protective shield that extends along the border between the front end and the passenger compartment.

In particular, forming can be direct or indirect hot forming. In the case of direct hot forming, the forming takes place after the semi-finished product has been heated to an increased temperature, which is particularly above the recrystallization temperature of the respective material. In the case of indirect hot forming, cold forming is carried out before the semi-finished product is heated. After cold forming, the semi-finished product is heated and hot-formed. In this case, the degree of forming in the hot forming, as compared to that of the cold forming, can be comparatively low. Both hot forming processes can provide for heat treatment to increase strength in the context of the hot forming. This means, in particular, that the heat treatment takes place while the semi-finished product that has already been hot-formed is still in the mold for hot forming.

In particular, before the forming is carried out, the semi-finished product can be made from a large number of, in particular flat, metal sheets which are materially connected in the area of their edges. Such semi-finished products are also referred to as so-called tailor-welded blanks. In particular, the edges of the individual sheets can be welded. However, it is also conceivable to connect the edges in an overlapping way. In this case, point welding methods can also be used. The use of other joining methods is also possible.

Alternatively and/or in addition, the semi-finished product may, before and/or during the forming, be manufactured by means of materially connecting at least one, in particular planar, reinforcing plate applied to an, in particular, flat metal sheet and/or to a plurality of sheets materially connected in the area of their edges with the metal sheet and/or the connected sheets. Such reinforcing plates are also known as patch reinforcements. These can be connected to the base plate by means of spot welding, laser welding and/or projection welding. In this case, the welding process is preferably carried out before forming. Alternatively and/or in addition, warm clinching, especially during forming, or the use of a soldering process to connect the reinforcing plates to the base plate is possible. A soldering process can be carried out, for example, by using a solder foil inserted between the reinforcing plate and the metal sheet and/or the connected sheets.

In other words, it is possible for the semi-finished product to be formed by applying one or more reinforcing plates as patch reinforcements to a one-piece sheet. It is also possible to first manufacture a tailor-welded blank, to which further reinforcing plates are then applied as patch reinforcements. A major advantage in the manufacturing of semi-finished products in the way described above is that it can be done by processing flat sheets. This considerably simplifies the process management in the manufacturing of the semi-finished product for forming. This applies in particular to the preferred material connection of the surfaces to each other and/or of the sheets and reinforcing plates by means of welding processes.

In particular, the material connection the sheets to each other and/or to at least one reinforcing plate can be carried out by laser beam welding. The preferred manufacturing of the semi-finished product by laser beam welding can be carried out in particular by laser remote welding. In remote welding or scanner welding, the positioning of the laser beam is carried out by and/or with the help of movable deflection mirrors. This makes it possible to achieve an efficient and highly automated manufacturing of semi-finished products for hot forming. In particular, laser remote welding can also be used to process large-area workpieces quickly, as the laser can act on the workpiece from a comparably large distance. The flat shape of the semi-finished products in the form of planar sheets, that is to say, in particular, flat and non-formed sheets, has a positive effect on the possibility of using the laser scanners in question to carry out the welding process.

In particular, the metal sheets and/or reinforcing plates may be sheets with different properties. In this way, bulkheads can be manufactured in which individual areas of the bulkhead can have different properties. In this way, the bulkhead can be specifically adapted to the requirements, especially the mechanical requirements placed on its individual areas. In particular, the behavior of individual areas of the bulkhead can be specifically influenced in the event of a deformation, for example in the event of a crash.

The different properties can be in particular different strengths and/or ductility. Different strengths can be understood as the tensile strength of the material, especially the steel used, in the finished workpiece. In this way, for example, zones with higher or lower strength and/or ductility can be realized in a targeted manner, which is particularly advantageous with regard to the adaptation of the bulkhead to the desired properties in the event of a crash. In particular, the ductility in the individual areas of the bulkhead can be adjusted differently in order to enable high degrees of deformation and thus a corresponding energy dissipation in the context of deformation in areas with higher ductility and lower strength, while in other areas the degree of deformation is correspondingly limited by their higher strength and lower ductility. Alternatively and/or in addition, the sheets and/or reinforcing plates used may have different thicknesses. By using different thicknesses, the strength of different areas of the bulkhead can also be specifically influenced. Alternatively and/or in addition, the use of different types of steel can also be considered in order to specifically influence the properties of different areas of the bulkhead.

Before and/or during forming, at least one section of the metal sheet and/or at least one of the connected sheets can be cut out. In particular, this makes it possible to create openings in the bulkhead. It is also possible to cut out a section of the edge of the metal sheet or the connected sheets. In this way, the edge contour of the bulkhead resulting in the course of forming can be specifically influenced in order to simplify or, in particular, completely replace any trimming of the edges that may be necessary after forming.

The cutting out of at least one section can be carried out mechanically before and/or during forming. In particular, the forming tool may have appropriate cutting edges through which the cutting is carried out during forming. Alternatively and/or additionally, the cutting out can be carried out by means of a laser. Here, too, laser remote cutting can be used in particular. Similar to the laser welding described above, the flat shape of the semi-finished product has a particularly advantageous effect in terms of processing time for laser remote cutting, but also for mechanical cutting.

In particular, openings may be provided in the semi-finished product which form openings in the bulkhead after the forming has been carried out. This can be done by cutting out at least one section, as described above. Alternatively and/or in addition, it is also possible, for example if the semi-finished product is a tailor welded blank, to provide the openings by omitting at least a section of the semi-finished product when producing the semi-finished product from a plurality of sheets. This has the advantage that the corresponding openings can be created without having to cut out material areas afterwards, which reduces the processing effort and can also lead to material savings.

The openings thus formed in the bulkhead may in particular be openings which serve to pass through structural elements of the motor vehicle body running in the longitudinal direction of the vehicle. In particular, such structural elements may be longitudinal members of the vehicle body. In this way, it is possible to connect these structural elements in an advantageous manner to the areas of the vehicle body behind the bulkhead.

In particular, after forming, the edge areas of the component can be cut to a desired contour. This makes it possible to manufacture very custom-fit bulkheads. The cutting of the edge areas is also advantageously carried out by means of laser cutting, in particular laser remote cutting. The forming process described above is particularly advantageous for the manufacturing of large-area bulkheads with a comparatively flat structure. Bulkheads shaped in this way are particularly suitable for cutting the edge areas by means of laser cutting, especially laser remote cutting. Alternatively and/or additionally, the edge areas of the semi-finished product can be cut to size before and/or during forming. In this case, mechanical cutting processes can also be used. In particular, cutting to size can be carried out by means of appropriate cutting edges in the forming tool. In this case, the edge area of the semi-finished product is cut to size in such a way that the desired contour of the edge area of the component is obtained due to the forming.

In particular, the method enables the manufacturing of bulkheads for vehicle bodies of a large number of different types of motor vehicles. For the manufacture of bulkheads for motor vehicle bodies of a number of different types of motor vehicles, a component with a spatial structure can be manufactured by means of forming, in addition to a flat semi-finished metallic product, wherein the component forms at least part of the bulkhead. Subsequently, the edge area of the component can be cut to a specific contour for the desired type of motor vehicle after the forming has been carried out. Alternatively and/or additionally, the edge area of the semi-finished product can be cut to size in such a way that, after forming, the contour specific to the desired type of motor vehicle is obtained. When forming is carried out, the identical tool is used for the manufacturing of bulkheads for different types of motor vehicles.

In this way, in particular, the method described above can be used as part of a platform strategy in the manufacturing of different types of motor vehicles. Different motor vehicles using a common platform may then differ, in particular in the external dimensions of the bulkhead used. This makes it possible to carry out the forming process, which is investment-intensive due to the cost of tooling, for a number of different types of motor vehicles with the same type of, and in particular the same, tool. The cutting of the edges of the hot-formed component and/or the semi-finished product, on the other hand, can be adapted comparatively easily to different contours of the resulting bulkheads specific to the respective desired type of motor vehicle. Ideally, this only requires intervention in the control of the cutting process, which may even be carried out in real time, that is to say, it may be possible to change the type of vehicle for which the bulkhead in question is intended “from bulkhead to bulkhead” during ongoing manufacturing without any delays.

In this context, laser cutting, especially laser remote cutting, is advantageous for cutting the edge area to size, as the high flexibility in the beam guidance of the laser beam allows for a great degree of freedom with regard to changing the cutting process to be carried out from component to component.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an exemplary bulkhead according to the conventional art,

FIG. 2 is an exemplary bulkhead manufactured using an exemplary inventive method,

FIG. 3 is a schematic representation of an exemplary semi-finished product prior to forming,

FIG. 4 is an exemplary bulkhead manufactured according to an inventive method as part of a motor vehicle body, and

FIG. 5 is a schematic representation of the adaptability of a bulkhead to different types of motor vehicles.

### DETAILED DESCRIPTION

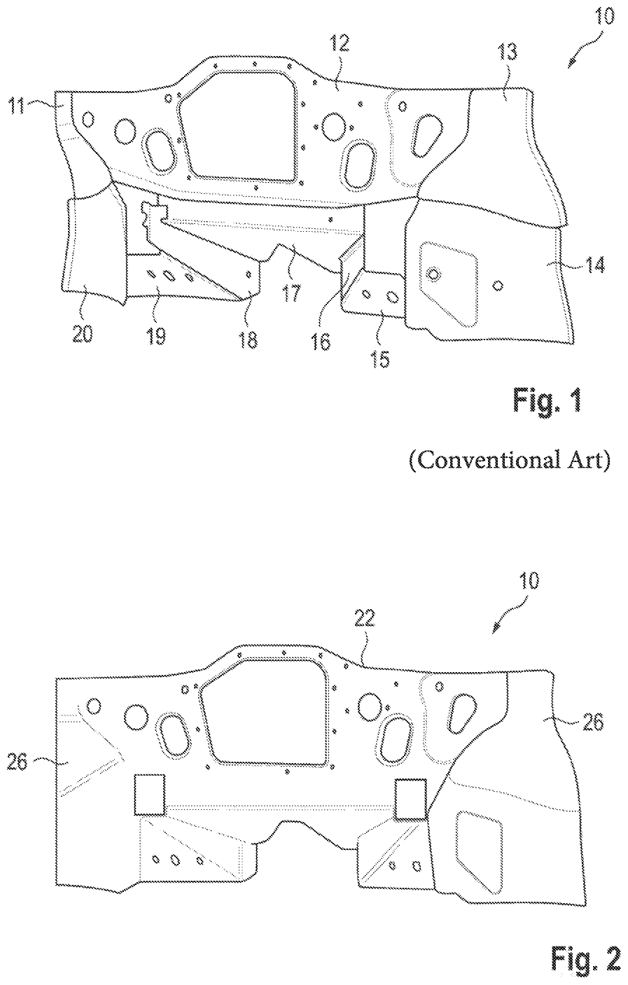

FIG. 1 shows an exemplary state-of-the-art motor vehicle bulkhead 10.

Such bulkheads are assembled from a series of preformed parts 11-20. In this context, preformed is to be understood in particular as meaning that the parts have already received their spatial structure through a forming process. For example, the parts 11-20 can be assembled to form the bulkhead 10 by welding. When looking at the connection between the individual parts 11-20, it becomes clear that the orientations of the weld seams or rows of weld points in relation to each other are very different. In particular, there are also angled transitions between the components, as for example in the transitions between the preformed parts 15 and 16, 16 and 17, 17 and 18, 18 and 20. Due to the angled location, the automation of the welding process is time-consuming. Here, for example, welding robots have to perform complex three-dimensional movements in order to reach the different locations of the bulkhead that are to be welded. The resulting welds must then be subjected to further processing, in particular for the purpose of corrosion protection. As a result, corrosion protection measures, such as PVC sealing seams, sometimes have to be carried out in places that are difficult to access. The process is comparatively time-consuming.

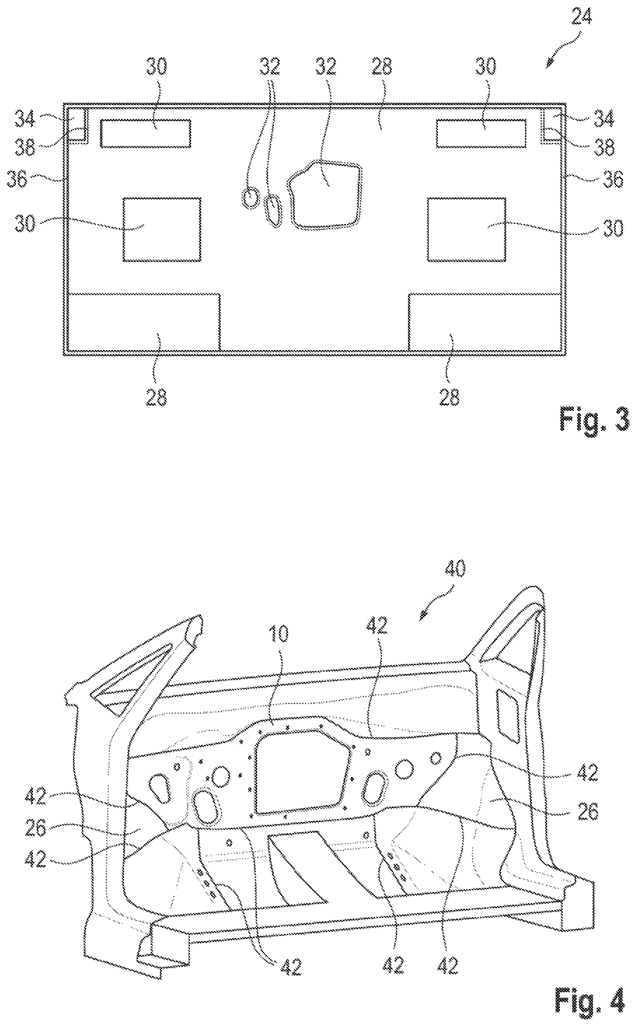

On the other hand, the exemplary bulkhead 10 shown in FIG. 2, manufactured by an inventive method, is advantageously formed by a component 22 which has been manufactured by the forming of a two-dimensional metallic semi-finished product 24. Such an exemplary semi-finished product 24 is shown schematically in FIG. 3.

The component 22 manufactured by the forming extends at least over sections 26 of both front wheel arches of the motor vehicle body. In particular, as in the example shown, such large-area components 22 can completely form the bulkhead 10.

The example of a semi-finished product 24 shown in FIG. 3 may be made from a plurality of sheets 28 which are materially connected in the area of their edges and which may have different properties. Alternatively and/or additionally, reinforcing plates 30 can be applied to the sheets 28. In this way, the bulkhead 10, which is made from the semi-finished product 24 by forming, acquires different material properties in different areas. For example, the individual sheets 28 can have different strengths, ductility and/or thicknesses. The same applies for the applied reinforcing plates 30.

In addition, the semi-finished product 24 may have openings 32, which are created by cutting out sections of the sheet 28. In addition, the semi-finished product 24 can already be shaped in the area of its edges by cutting out sections 34 of the edges. To illustrate this, the example shown shows the original contour 36 of the sheet 28, from which the sections 34 were cut, as well as the contour 38 of the semi-finished product 24 resulting from the cutting out of the sections 34 before forming.

FIG. 4 shows an exemplary bulkhead after forming as part of a motor vehicle body 40. It can be seen that the bulkhead 10 extends over sections 26 of the motor vehicle body 40. The method according to the invention makes it possible to manufacture such a large-area bulkhead as a one-piece hot-formed component, the different areas of which have different properties. By way of example, FIG. 4 shows area boundaries 42, which visually separate areas with different material properties, such as different strength and/or thickness, from each other for display purposes. In practice, in the course of material forming, flowing material transitions arise, which, in contrast according to the conventional art of the welds between the individual parts 11-20 in the bulkhead 10 shown by way of example in FIG. 1 that must be each treated separately after welding. In this way, due to the inventive method, the bulkhead 10 can be manufactured as a highly optimized component yet also cost-effective.

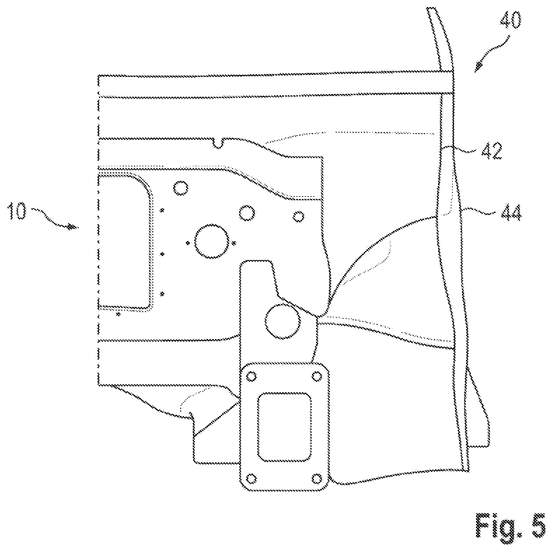

FIG. 5 shows schematically how such an inventive bulkhead 10 manufactured by forming can be adapted to the vehicle bodies of 40 different types of motor vehicles. Depending on the design of the motor vehicle body 40, the bulkhead 10 can be given the exemplary contour 42 or the contour 44, which is also shown as an example, by cutting the edge of the bulkhead 10 to size. In particular, within the framework of a platform strategy, the manufacturing of the bulkheads 10 can be adapted to different types of motor vehicles, in which the bulkheads 10 differ essentially in the contour of their edge area. For example, in the example shown, a bulkhead 10 with the contour 42 can fit into the narrow body of a first type of motor vehicle, while the contour 44 of the bulkhead 10 is adapted to the (shown) wider body 40 of a second type of motor vehicle. In this way, the bulkheads 10 manufactured according to the inventive method can be easily adapted to different types of motor vehicles using the identical hot forming tool.

The features of the invention disclosed in the present description, the drawings and claims may be essential to the realization of the invention in its various embodiments, either individually or in any combination. The invention can be varied within the scope of the claims and taking into account the knowledge of the competent skilled person.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to manufacture a bulkhead of a motor vehicle body, the method comprising:
forming front wheel arches of the motor vehicle body, at least in part, by the bulkhead of the motor vehicle; and
forming a two-dimensional metallic semi-finished product into a component with a spatial structure, the component forming at least part of the bulkhead,
wherein the component manufactured by the forming process forms at least part of the bulkhead and extends at least over sections of both front wheel arches of the motor vehicle body.

2. The method according to claim 1, wherein the forming is a direct or indirect hot forming.

3. The method according to claim 1, wherein the semi-finished product is manufactured from a plurality of plates connected to each other in an area of their edges before the forming process is carried out.

4. The method according to claim 1, wherein the semi-finished product is manufactured, before and/or during the forming, by materially connecting at least one reinforcing plate, which is applied to a metal sheet and/or to a number of sheets materially connected to each other in the area of their edges, to the metal sheet and/or to the connected sheets.

5. The method according to claim 3, wherein the material connection of the sheets to each other and/or with the reinforcing plate is carried out by laser beam welding or laser remote welding.

6. The method according to claim 3, wherein the metal sheets and/or reinforcing plates are sheets with different properties or different strengths and/or thicknesses.

7. The method according to claim 1, wherein before and/or during the forming process, at least a section of the metal sheet and/or at least one of the connected sheets is cut out by mechanical cutting.

8. The method according to claim 1, wherein the semi-finished product is provided with openings, which, after the forming has been carried out in the bulkhead, form openings for a passage of structural elements of the motor vehicle body running in the longitudinal direction of the vehicle.

9. The method according to claim 1, wherein an edge area of the component is cut to a desired contour after hot forming and/or an edge area of the semi-finished product is cut to size in such a way that the desired contour is obtained after forming.

10. A method to manufacture a bulkhead for motor vehicle bodies of a plurality of different types of motor vehicles by the method according to claim 1, the method comprising:
forming a two-dimensional metallic semi-finished product into a component with a spatial structure, the component forming at least part of the bulkhead;
cutting an edge area of the component to a specific contour for the desired type of motor vehicle after hot forming has been carried out and/or an edge area of the semi-finished product is cut to size such that, after forming, the contour specific to the desired type of motor vehicle is obtained; and
using, when the forming is carried out, the identical tool for the manufacturing of the bulkheads is used for the different types of motor vehicles.
